(19) United States
(12) Patent Application Publication
(10) Pub. No.: US 2012/0162651 A1
(43) Pub. Date: Jun. 28, 2012

(54) APPARATUS AND METHOD FOR MEASURING TRANSMITTANCE

(75) Inventor: James Andrew Glover, Whitby (CA)

(73) Assignee: REAL TECH INC., Whitby, ON (CA)

(21) Appl. No.: 13/380,798

(22) PCT Filed: Jun. 29, 2010
(86) PCT No.: PCT/CA10/01061

§ 371 Date: Mar. 19, 2012

Related U.S. Application Data
(60) Provisional application No. 61/221,458, filed on Jun. 29, 2009.

(51) Int. Cl. G01N 21/59

(52) U.S. Cl. 356/434

(57) ABSTRACT

A device to measure the amount of light able to transmit through a liquid. The device uses a light detector and light source mounted to a support mechanism such that the detector and light source define a path of light emitted by the light source and detected by the detector. The device uses a structure designed to surround a liquid to be tested such that the structure allows light to transmit through the structure and the liquid. An actuator engenders relative motion between the support mechanism and the structure such that at certain times the light propagating between the light source and the detector passes substantially through the structure and the liquid to be tested such that the amount of light able to transmit through the liquid is detected by the detector, and at other times the light propagates directly from the light source to the detector without passing through the structure or the liquid such that the amount of light emitted from the light source is directly detected by the detector. A microprocessor then uses the two sets of detector readings to allow the transmittance measurement of the liquid to be compensated for errors introduced by drift and fluctuations in the amount of light emitted by the light source and also by drift in the light detector and electronics. Such fluctuation and drift is very common in light sources and is due primarily to changes in temperature and imperfections in the light source itself and the power supply.

### FIELD OF THE INVENTION

The present invention is related to real-time industrial and municipal water and liquid quality monitoring. This type of device is used in a variety of applications such as monitoring quality of plant effluent, industrial process control, and security monitoring of drinking water distribution systems.

### BACKGROUND OF THE INVENTION

Recently, industry and government have begun to realize the value of continuous monitoring of process parameters for a variety of applications. It is now understood that being able to monitor process variables in real-time allows operators to adjust the process parameters without delay so that the process can be continuously optimized. This can have wide ranging benefits such as cost reduction, improved quality, faster production and reduced waste. An example this kind of thinking is the recent push for process analytical technology (PAT) in the pharmaceutical industry.

Real-time transmittance and absorbance monitoring devices are some of the most applicable technologies for continuous monitoring of a variety of water quality parameters. This is partially due to their versatility since so many parameters can be determined with the use of certain wavelengths of light.

However, current transmittance monitoring technologies require improvement. One of the main issues affecting the accuracy, cost and maintenance of current transmittance monitoring devices is a lack of stability of the output of the light sources. This lack of stability manifests as sudden output fluctuations over the short term, medium term drift due to temperature and humidity effects on the lamp and power supply electronics, and long term drift due to aging of the light source.

Several methods commonly used to deal with the light source stability issue are: use of very high quality lamp and power supply electronics; use of complicated optics to split the light path to two sensors such that one sensor looks at the transmittance and the other sensor looks at the lamp output such that compensation is made for light source instability; use of beam splitting optics with a light beam chopper to allow the use of a single sensor by alternating transmittance and lamp output measurements for stability compensation; use of multiple path-length technologies for stability compensation which require either the use of multiple sensors; use of wetted moving parts, or place practical upper and lower limits on effective path-length; use of a reference wavelength outside the absorbance spectrum of the particular agent being monitored which assumes lamp fluctuations occur identically at all wavelengths emitted by the lamp and assumes that there is in fact a wavelength that is outside the absorbance spectrum of the particular agent being monitored.

Therefore, there is a need for a transmittance measuring device which avoids the aforementioned limitations.

### SUMMARY OF THE INVENTION

The present invention provides a device that monitors light transmittance using an inexpensive light source and power supply by compensating for light source drift and fluctuations using only one light sensor and one light beam without an expensive optical system, without practical limitations on path-length, and without the errors caused by using reference wavelengths.

In an aspect of the present invention there is provided an apparatus for measuring a transmittance of light through a target substance, the apparatus comprising: a light source for emitting light; a light detector for detecting an intensity of light; a support mechanism on which the light source and the light detector are mounted in a spaced apart relationship thereby defining a straight light path from the light source to the light detector, an actuator for engendering relative motion between the support mechanism and the target substance to at least a first position and a second position, where in the first position the target substance substantially intersects the light path and in the second position the target substance does not substantially intersect the light path. Preferably, the support mechanism is movable to at least a first and a second position with respect to the target, where in the first position the target substance substantially intersects the straight light path and in the second position the target substance does not substantially intersect the straight light path.

The target substance may be a solid, or it may be a fluid, and wherein the apparatus further comprises a structure capable of containing the fluid. Preferably, the apparatus includes a digital computer capable of controlling the actuator and receiving light intensity signals from the light detector. Even more preferably, the digital computer is a microprocessor connected to the light detector and to the actuator.

In a further embodiment of the present invention, the actuator may be a rotational actuator; wherein in the first position the support mechanism and the target are at a first angle with respect to each other, and in the second position the support mechanism and the target are at a second angle with respect to each other. In this embodiment, the rotational actuator preferably rotates along an axis of rotation that does not intersect the target substance.

In a further embodiment of the present invention, the target substance is a fluid; the apparatus further comprises a structure enclosing the support mechanism, the light source, and the light detector; the structure including at least one orifice and least one translucent region; the translucent region substantially intersects the straight light path when in the second position; the orifice allows for fluid to flow into and out of the structure; and the orifice substantially intersects the straight path when in the first position. In this embodiment, the actuator is preferably a linear actuator. Preferably, the translucent region is a cell containing one of vacuum and air. Even more preferably, the structure includes a first and second region, the light source contained in the first region, and the light detector contained in the second region; and the straight light path intersects at least a portion of the structure when in one or both of the first position and the second position. Preferably, the first and second region are tubular in shape, and the first translucent region is a tube that substantially intersects the straight light path when in the first position, and the second translucent region is a pair of opposing windows that substantially intersects the straight light path when in the second position.

In a further aspect of the present invention, there is provided a method for measuring a transmittance of light through a target substance, the method comprising: providing an apparatus comprising: a light source for emitting light; a light detector for detecting an intensity of light; a support mechanism on which the light source and the light detector are mounted in a spaced apart relationship thereby defining a straight light path from the light source to the light detector, the support mechanism being movable to at least a first and a second position with respect to the target, where in the first position the target substance substantially intersects the straight light path and in the second position the target substance does not substantially intersect the straight light path; and an actuator for moving the support mechanism into the first position and the second position with respect to the target; performing a first measurement step and a second measurement step in either order, the first measurement step including signaling the actuator to move the support mechanism to the first position and subsequently storing in memory a first value corresponding to a first signal received from the light detector; and the second measurement step including signaling the actuator to move the support mechanism to the second position and subsequently storing in memory a second value corresponding to a second signal received from the light detector. Preferably, the method further comprises the step of: computing a ratio of the first value and the second value.

In a further aspect of the present invention there is provided an apparatus for measuring a transmittance of light through a target substance comprising: a light source capable of emitting light; a light detector capable of detecting an intensity of light; a support mechanism on which the light source and the light detector are mounted in a spaced apart relationship thereby defining a path of light from the light source to the light detector; and an actuator for engendering relative motion between the support mechanism and the target substance to at least a first position and a second position; wherein in the first position the target substance substantially intersects the path of light and in the second position the substance does not substantially intersect the path of light.

In a further aspect of the present invention there is provided a method for measuring a transmittance of light through a target substance using the apparatus provided in the invention, the method comprising: performing a first measurement step and a second measurement step in either order, wherein the first measurement step includes signaling the actuator to engender relative motion between the support mechanism and the target substance to the first position and subsequently storing in memory a first value corresponding to a first signal received from the light detector; and wherein the second measurement step includes signaling the actuator to engender relative motion between the support mechanism and the target substance to the second position and subsequently storing in memory a second value corresponding to a second signal received from the light detector. Further, one may additionally perform the step of: computing a ratio of the first value and the second value.

A further understanding of the functional and advantageous aspects of the present invention can be realized by reference to the following detailed description and drawings.

### BRIEF DESCRIPTION OF THE DRAWINGS

The invention will be more fully understood from the following detailed description thereof taken in connection with the accompanying drawings, which form a part of this application, and in which:

FIG. 1 is a block diagram showing a light transmittance measuring device constructed in accordance with the present invention, in a first position (a) and in a second position (b);

FIG. 2 is the diagram of FIG. 1 including windowed apertures 5, in a first position (a) and in a second position (b);

FIG. 3 is a front view of an embodiment of the present invention using a rotational actuator;

FIG. 4 is a side view of FIG. 3 a first position (a) and a second position (b);

FIG. 5 is a front view of an embodiment of the present invention using a linear actuator, in a first position (a) and in a second position (b);

FIG. 6 is a top view of an embodiment of the present invention using a rotational actuator, in a first position (a) and in a second position (b); and

FIG. 7 is a front view of FIG. 6.

### DETAILED DESCRIPTION OF THE INVENTION

Without limitation, the majority of the systems described herein are directed to an apparatus and method of measuring optical properties of water. As required, embodiments of the present invention are disclosed herein. However, the disclosed embodiments are merely exemplary, and it should be understood that the invention may be embodied in many various and alternative forms.

The figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention. For purposes of teaching and not limitation, the illustrated embodiments are directed to real-time industrial and municipal water and liquid quality monitoring.

As used herein, the term “about” or “approximately”, when used in conjunction with ranges of dimensions, temperatures or other physical properties or characteristics is meant to cover slight variations that may exist in the upper and lower limits of the ranges of dimensions as to not exclude embodiments where on average most of the dimensions are satisfied but where statistically dimensions may exist outside this region. For example, in embodiments of the present invention dimensions of components of an apparatus and method of measuring optical properties of water are given but it will be understood that these are non-limiting.

As used herein, the coordinating conjunction “and/or” is meant to be a selection between a logical disjunction and a logical conjunction of the adjacent words, phrases, or clauses. Specifically, the phrase “X and/or Y” is meant to be interpreted as “one or both of X and Y” wherein X and Y are any word, phrase, or clause.

As used herein, the term “fluid” refers to any liquid, gas, or substance that continually deforms under an applied shear stress.

As used herein, the term “light” refers to any electromagnetic radiation, and is not limited to wavelengths of visible light. For example, “light” may refer to radio waves, microwaves, infrared radiation, visible light, ultraviolet radiation, X-rays, or gamma rays.

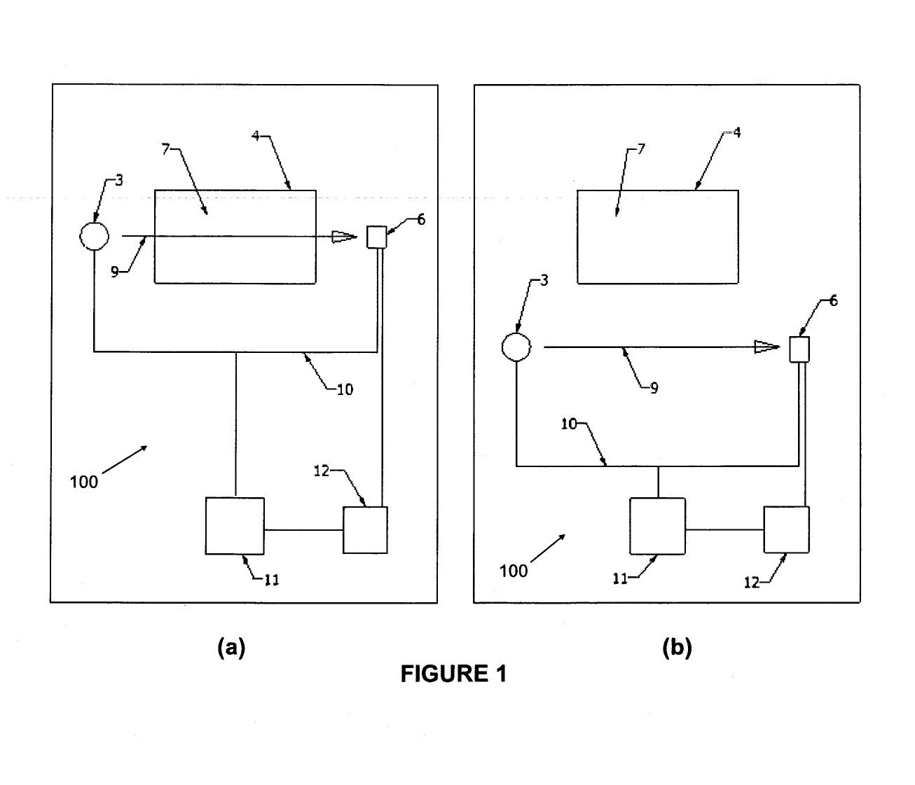

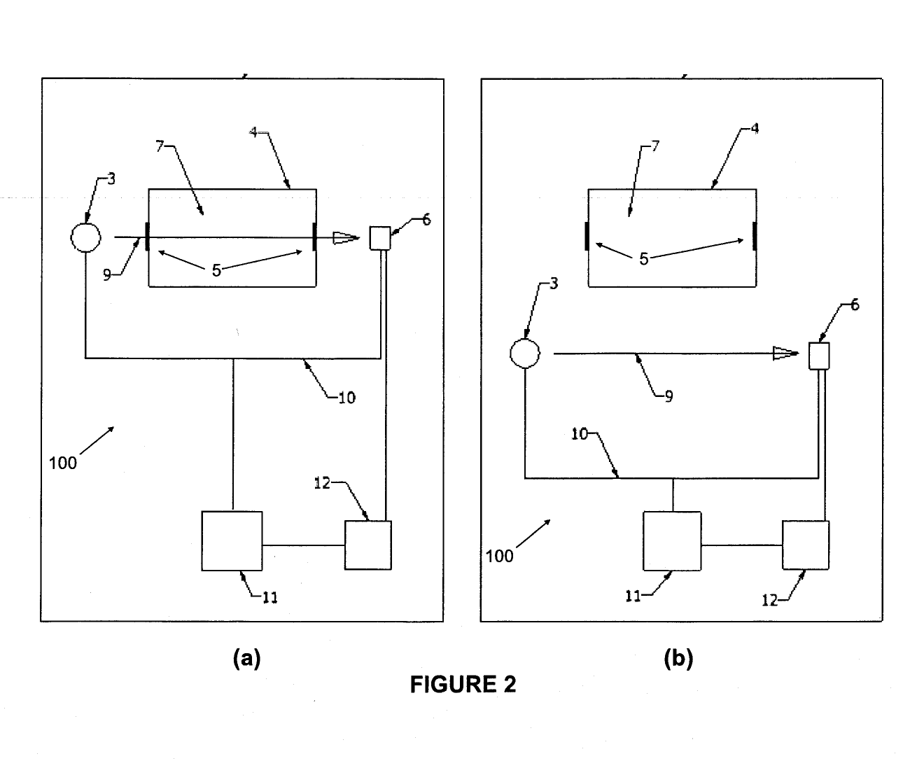

Referring to FIG. 1, a light transmittance measuring apparatus constructed in accordance with the present invention is shown generally at 100. FIG. 1(a) shows apparatus 100 in the first position and FIG. 1(b) shows apparatus 100 in the second position. FIG. 2 shows the device further including apertures 5, described below.

Generally speaking, a preferred embodiment of the present invention operates by comparing the transmittance of light through a test substance to the transmittance of light in the ambient environment. In a preferred embodiment, the test substance is a liquid, though the test substance may be any substance of interest. Referring to FIG. 1, light source 3 and light detector 6 are mounted spaced apart from each other and define a light path 9 emitted from light source 3 and detected by light detector 6. Light source 3 and light detector 6 may be mounted to moveable support mechanism 10. Preferably, light source 3 emits light of a wavelength or set of wavelengths that can be transmitted by the test substance 7.

When test substance is a fluid, apparatus 100 preferably includes structure 4 which surrounds test substance 7 and is designed to allow light to transmit through both structure 4 and test substance 7. As shown in FIG. 2, structure 4 may optionally include apertures 5 on opposed faces of structure 4 to intersect light path 9. Apertures 5 allow structure 4 to be opaque and/or made of metal. If windowed apertures 5 are included then it is preferable that they be substantially transparent to the light emitted by light source 3.

As shown in FIG. 1, an actuator 11 is mounted to moveable support mechanism 10 such that the moveable support mechanism can be moved between different positions. In a preferred embodiment, actuator 11 moves moveable support mechanism 10 between at least two preselected positions. The first position (FIG. 1(a)) is the position at which the light path 9 passes substantially through the structure 4 and test substance 7. The second position (FIG. 1(b)) is the position at which the light path 9 passes substantially uninterrupted from light source 3 to light detector 6.

Microprocessor 12 is connected to both actuator 11 and light detector 6. Microprocessor 12 synchronizes the movement of the moveable support mechanism 10 via the actuator 11 with the sampling of the signal produced by light detector 6. When apparatus 100 is undergoing normal operation, the microprocessor 12 first signals actuator 11 to move moveable support mechanism 10 into the first position (FIG. 1(a)). The microprocessor 12 then reads a signal from the light detector 6 and stores the received signal as a first digital value. This first digital value is generally a function of the intensity of light emitted from light source 3, the performance of the light detector 6, and the presence of matter in the test substance 7 that absorbs light at the wavelength or set of wavelengths emitted by light source 3 and detected by light detector 6. The microprocessor 12 then signals actuator 11 to move moveable support mechanism 10 into the second position (FIG. 1(b)). The microprocessor reads the signal from the light detector 6 and converts this to a second digital value. This second digital value is generally affected only by the intensity of light emitted from light source 3 and the performance of the light detector 6. The microprocessor 12 computes the ratio of the first digital value to the second digital, which provides a measure of the intensity of light transmitted through the test substance 4 independent of the intensity of light emitted from light source 3 and the performance of the light detector 6. This procedure may be repeated continuously or the procedure may be timed to perform at certain time intervals. This procedure may be performed in the opposite manner, namely that the second position (FIG. 1(b)) may be measured first, and the first position (FIG. 1(a)) may be measured second. Any particular order of the positioning is not important for the measurement procedure, though it is preferable that the microprocessor 12 have means of determining the position of moveable support 10 at the time of reading the signal from light detector 6.

Additionally, computed ratios for liquids containing known levels of light transmittance may be stored in memory. This allows future ratios of liquids containing unknown levels of light absorbing matter to be compared with the stored values to allow correlations between the measured transmittance of light through the test substance and the actual level of light absorbing matter in the test substance.

It will be appreciated that windowed apertures 5 could be designed such that these apertures help to direct the light through the structure in a narrow beam for the purpose of reducing stray light. Further, a lens (not shown) transparent to a desired wavelength of light could be fixed in front of light source 3 to focus the light into a narrow beam towards the light detector 6 with a purpose of reducing stray light. Further, a lens transparent to a wavelength of light could be positioned in the light path 9 in front of the light detector 6 in order to collect and focus the light that is transmitted from light source 3.

Those skilled in the art will appreciate that light source 3 may be any source of electromagnetic radiation emitting any range of wavelengths, including but not limited to a mercury lamp, a deuterium lamp, a xenon lamp, a tungsten lamp, a halogen lamp, and an LED light source. Light detector 6 may be any electromagnetic radiation detector capable of detecting an intensity of light of the wavelength or set of wavelengths that can be transmitted by the type of matter in the test substance 7, such as a solid state light detector. Preferably, light source 3 and light detector 6 are connected to microprocessor 12 via conductive wires; though they may be connected with other means such wireless receiver and transmitter.

It is often desirable to emit specific wavelengths from light source 3 by either filtering the light output (filter not shown) or by using a plurality of light sources, each emitting set wavelengths of light, collectively forming a light source. These specific wavelengths can be any arbitrary preselected wavelength spectrum, or can be a narrow band of wavelengths. Further, it is often desirable to have the light source 3 emit different light wavelength spectra at different times, which can be controlled by the microcontroller 12. In this configuration, it is further desirable to have the detector be able to resolve the intensity of the different wavelength components of the incoming light signal, i.e. an intensity spectrum. Given such a detector that can resolve the range of wavelengths of light into substantially individual wavelengths of light, a light transmittance spectrum can be calculated.

The accuracy and range of the apparatus is directly affected by the length of light path 9 the thickness of test substance 7. The distance between the windowed apertures 5 can be any distance in theory, though practical constraints limit this distance to be generally but not limited to between about 1 mm and about 600 mm. A longer light transmittance distance through the test substance can improve performance when measuring the light transmittance of liquid with high purity, yet this can decrease performance when measuring the light transmittance of liquid with low purity. A shorter light transmittance distance through the test substance can reduce performance when measuring the light transmittance of liquid with high purity, yet this can increase performance when measuring the light transmittance of liquid with low purity. The final computed light transmittance value can be scaled in software to provide a measurement relative to a particular light transmittance distance through the test substance.

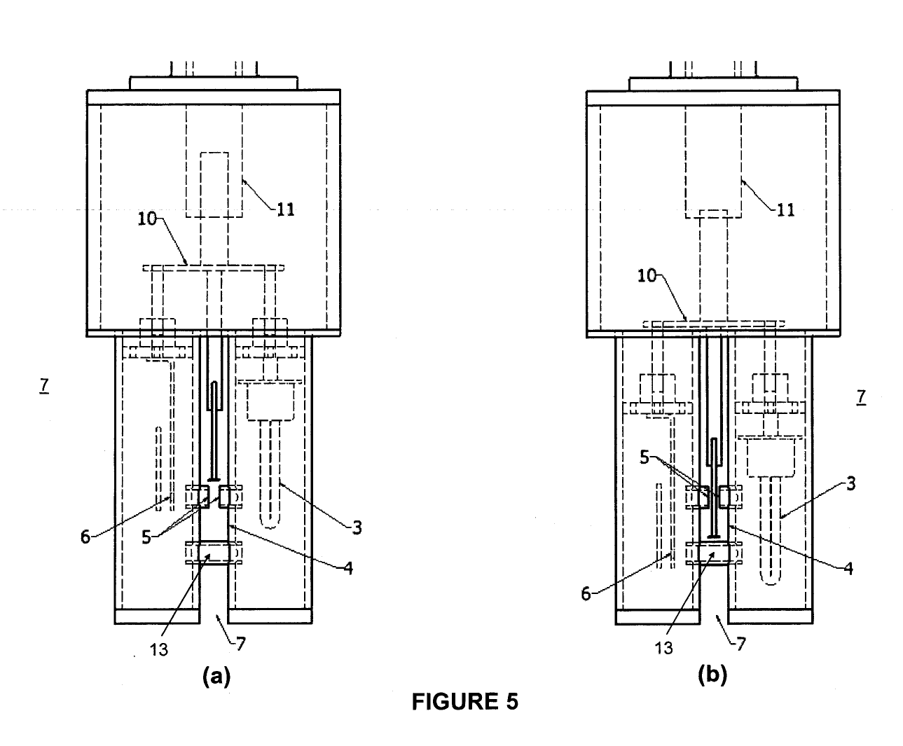

The structure 4 can be a flow cell including an influent or inlet port and an effluent or outlet port to allow the test substance 7 to flow through the structure 4 at a particular flow rate via tubing designed to carry the test substance 7 to and from the structure 4. Alternatively, the structure 4 can be part of the external walls of the apparatus such that the test substance 7 surrounds the apparatus and is able to freely flow between the opposed windowed apertures 5 embedded in the structure 4 (FIG. 5, described later). The structure 4 could also be such that the test substance 7 is exchanged at certain times in a batch style process.

Those skilled in the art would appreciate that actuator 11 may be any device that engenders relative motion between moveable support mechanism 10 and test substance 7. Some non-limiting examples include: linear solenoid, linear stepper actuator, stepper motor, servo motor, rack and pinion connected to a DC motor, and cam mechanism connected to a DC motor. Actuator 11 can make use of absolute or relative positioning techniques. For example, if a stepper motor is used the positions can be determined by counting the number of steps from one position to the next and recording this by microprocessor 12. Alternatively, if the actuator 11 is a simple DC motor, the microprocessor 12 may make use of additional sensors such as photodiodes or micro-switches to allow signals to be produced when the moveable support mechanism 10 reaches a particular position. The actuator may also make use of mechanical stops to allow proper positioning of the moveable support mechanism 10.

When the light source 3 is first turned on it is allowed to reach a stable operating output characterized by a manageable amount of light intensity drift over time, as measured by the light detector 6, before normal operation is begun. Microprocessor 12 can be programmed to determine when the intensity of light from of light source 3 has become stable enough by measuring and comparing the light source intensity using the light detector 6 at predetermined time intervals.

The accuracy of light detector 6 readings, whether they measure light source intensity directly or the amount of light transmitted through the test substance 7, can be improved by using signal conditioning electronics and/or by using various software averaging algorithms. In the preferred embodiment of the invention, signal conditioning electronics is used to improve light detector 6 reading accuracy. Such signal conditioning electronics include but are not limited to trans-impedance amplifiers, signal gain amplifiers, and analog to digital converters (ADCs).

Software running on microprocessor 12 can be implemented to average sample sets read from the light detector 6, thereby smoothing out the measured signal. This can further improve the accuracy and increase the signal to noise ratio.

For applications desiring the light absorbance of the test substance 7, the microprocessor 12 can calculate the light absorbance by evaluating a negative logarithm of the measured light transmittance.

The apparatus may be configured to further include a second light detector to measure the light intensity of light source 3 directly at all times. The purpose of the second light detector is to allow the microprocessor 12 to correct for changes in light intensity that occur between the times when the light detector 6 is read in first position 1 and in second position 2. This allows the device to automatically correct for any light source intensity fluctuations that occur during this short interval.

Another way to reduce errors caused by changes in light source output that occur between the times when the light detector 6 is read in first position 1 and in second position 2, is to use a software trending algorithm. Microprocessor 12 may use a software trending algorithm to allow the light source intensity to be approximately predicted from previous readings from the light detector 6, in the attempt to predict and therefore correct for any changes in light source intensity that occur during this short interval.

Such a trending algorithm may be a linear trend, which computes the average local rate of change and assumes that the local rate of change is constant. An alternative trending algorithm is polynomial interpolation where software running on microprocessor 12 fits a polynomial to past data points and evaluates the polynomial to estimate present and future data points. A further possible trending algorithm is evaluation of a statistical model where past data points form the basis for calibration of the statistical model. Those skilled in the art will appreciate that there are other algorithms for processing the signals received from light detector 6. The above examples are not intended to exclude other signal processing methods.

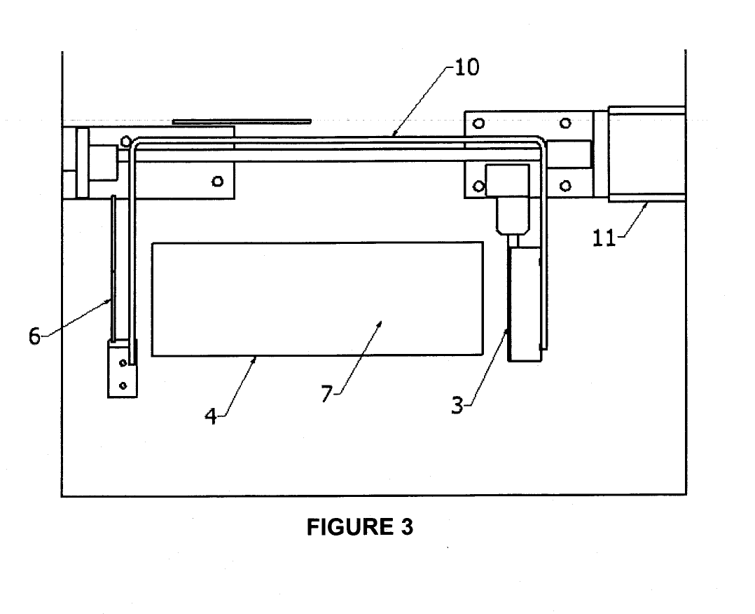

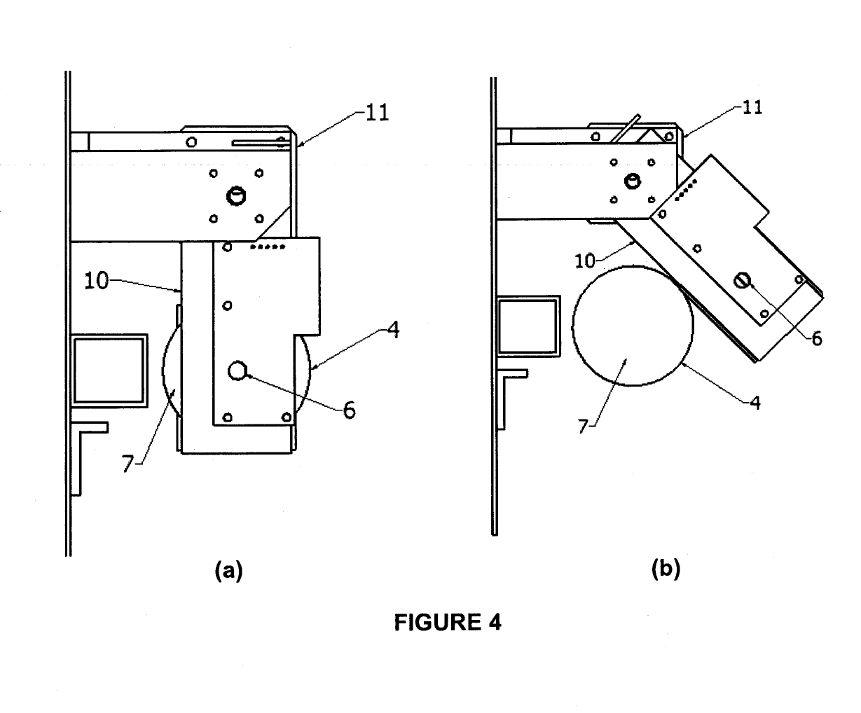

FIGS. 3 and 4 show an embodiment of the present invention wherein rotational actuator 11 is coupled to support mechanism 10, Light detector 6 and light source 3 are mounted on support mechanism 10 to form a fixed light path therebetween. Rotational actuator 11 is capable of rotating support mechanism 10 into at least a first and second position. In the first position (FIG. 4(a)), the light path between light source 3 and light detector 6 substantially passes through test substance 7. In the second position (FIG. 4(b)), the light path is relatively uninterrupted between the light source 3 and light detector 6. This embodiment may have a microcontroller attached to the apparatus (not shown), or may comprise any digital computer connected to the light detector 6 and actuator 11.

A further embodiment of the present invention is shown in FIG. 5, wherein the apparatus may be immersed in test fluid 7. Test fluid 7 is free to flow across the region between translucent windowed apertures 5 which function as closed windows translucent to a preselected spectrum of wavelengths of light. Structure 4 encases the device and the windowed apertures 5 are substantially secured to the structure 4. Preferably, structure 4 is filled with air or a vacuum. Support mechanism 10 has light source 3 and light detector 6 mounted thereto, thereby maintaining the distance between light source 3 and light detector 6. Linear actuator 11 is capable of translating the support mechanism 10, and may be a linear solenoid, linear stepper actuator, stepper rack and pinion connected to a DC motor, a cam mechanism connected to a DC motor, or any other electrically controlled device capable of producing linear motion.

Referring to FIG. 5, linear actuator 11 is capable of translating support mechanism 10 to at least a first and second position. In the first position (FIG. 5(a)), a light path between light detector 6 and light source 3 passes substantially through the test fluid 7 and the translucent windowed apertures 5. In the second position (FIG. 5(b)), the light path substantially passes through tube 13 that substantially does not absorb any of the preselected spectrum of wavelengths. Tube 13 generally provides a straight light path for light to pass through unobstructed. Any translucent region that intersects a portion of the straight light path between the light detector 6 and light source 3 will function in place of tube 13. To measure the transmittance of the test fluid 7 surrounding the device, the linear actuator 11 first moves the support mechanism 10 into the first position (FIG. 5(a)). A digital computer or microprocessor (not shown) records a light intensity measured by the light detector 6. The actuator then moves the support mechanism 10 into the second position (FIG. 5(b)) where the path of light substantially passes through the translucent region in tube 13, and a second measurement is made. The measurements can be made in either order; it is the ratio of the two measurements that allow calculation of the transmittance of the fluid. The embodiment of FIG. 5 effectively forms a test probe that allows for continuous measurement of fluid transmittance and absorbance. Preferably, structure 4 is transparent in regions that require measurement, namely where the path of light intersects structure 4 in the first position and the second position.

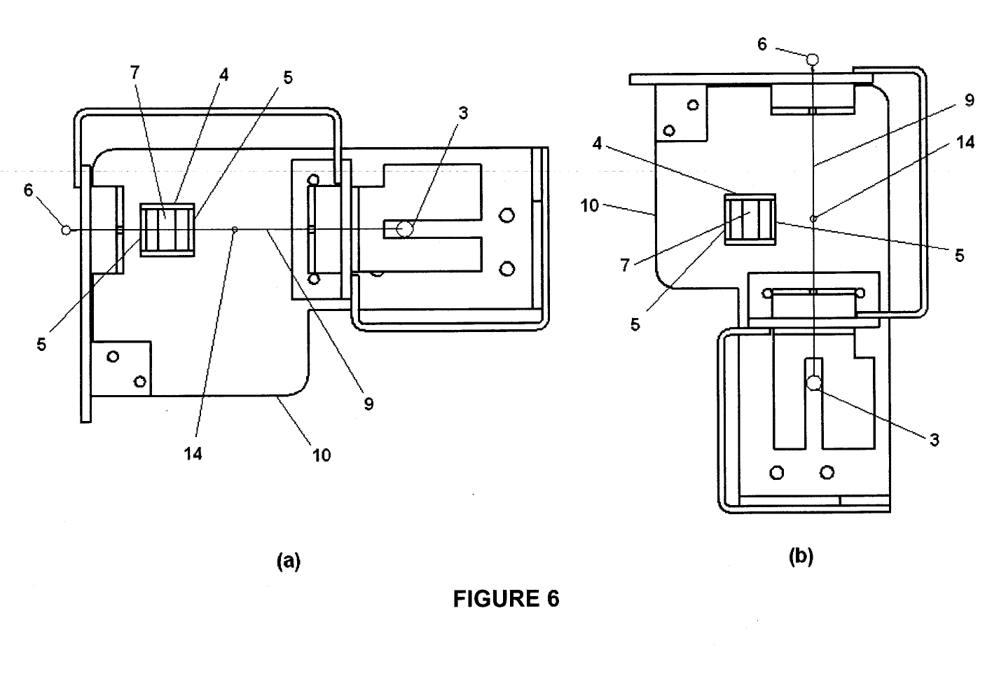

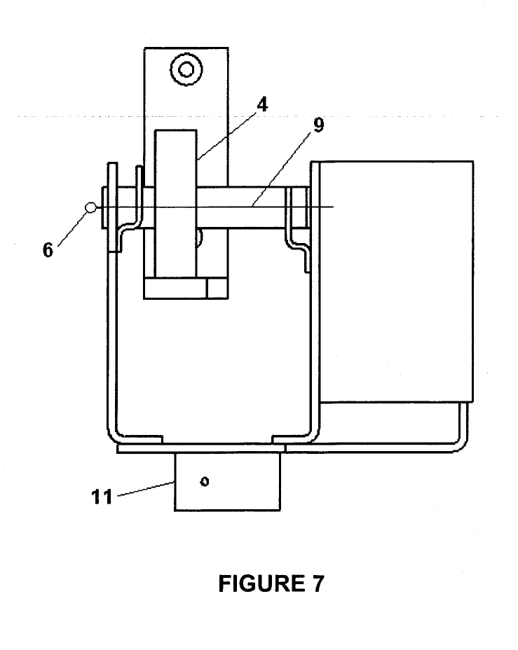

FIGS. 6 and 7 show a further embodiment of the present invention wherein rotational actuator 11 is coupled to support mechanism 10. Light detector 6 and light source 3 are mounted on the support mechanism 10 to form a straight light path 9 therebetween. Structure 4 is fixed relative to support mechanism 10 and may contain translucent windows 5. Structure 4 is not attached to support mechanism 10 and is preferably kept in place with a bracket. Rotational actuator 11 is capable of rotating support mechanism 10 into at least a first and second position, rotated about axis of rotation 14. In the first position (FIG. 6(a)), the light path between light source 3 and light detector 6 substantially passes through test substance 7. In the second position (FIG. 6(b)), the light path is relatively uninterrupted between the light source 3 and light detector 6. This embodiment may have a microcontroller attached to the apparatus (not shown), or may comprise any digital computer connected to the light detector 6 and actuator 11. Structure 4 is mounted adjacent to the axis of rotation of the rotational actuator 14, which allows the light path to intersect the test substance 7 in only one of the two positions.

It would be appreciated by those skilled in the art that other embodiments of the present invention may be used. For example, the actuator 11 may move structure 4 instead of the support mechanism 10, thereby achieving the same relative motion as illustrated in FIG. 1. With this configuration, the actuator would be coupled to the structure 4, rather than the support mechanism 10. While the preferred embodiment of the present invention is to use a microcontroller 12, it is not necessary to have a microprocessor contained in the apparatus controlling the sensors. The signal from the light detector may be sent to any digital computer, wherein a different computer signals the actuator. Further, the target substance intersecting the path of light 9 need not be a liquid contained in a structure. Any substance can be contained in the structure 4. If a translucent solid is to be measured in place of test substance 7, structure 4 is not necessary.

As used herein, the terms “comprises”, “comprising”, “including” and “includes” are to be construed as being inclusive and open ended, and not exclusive. Specifically, when used in this specification including claims, the terms “comprises”, “comprising”, “including” and “includes” and variations thereof mean the specified features, steps or components are included. These terms are not to be interpreted to exclude the presence of other features, steps, or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

1. An apparatus for measuring a transmittance of light through a target substance, the apparatus comprising:
a light source for emitting light;
a light detector for detecting an intensity of light;
a support mechanism on which the light source and the light detector are mounted in a spaced apart relationship thereby defining a straight light path from the light source to the light detector, and
an actuator for engendering relative motion between the support mechanism and the target substance to at least a first position and a second position, where in the first position the target substance substantially intersects the light path and in the second position the target substance does not substantially intersect the light path.

2. The apparatus of claim 1 wherein the support mechanism is movable to at least a first and a second position with respect to the target, where in the first position the target substance substantially intersects the straight light path and in the second position the target substance does not substantially intersect the straight light path.

3. The apparatus of claim 1 further including a digital computer capable of controlling the actuator and receiving light intensity signals from the light detector.

4. The apparatus of claim 3 wherein the digital computer is a microprocessor connected to the light detector and to the actuator.

5. The apparatus of claim 3 wherein the target substance is a solid.

6. The apparatus of claim 3 wherein the target substance is a fluid, and wherein the apparatus further comprises a structure capable of containing the fluid.

7. The apparatus claim 3 wherein the actuator is selected from the group consisting of: linear solenoid, linear stepper actuator, stepper motor, servo motor, rack and pinion connected to a DC motor, and cam mechanism connected to a DC motor.

8. The apparatus claim 3 wherein the actuator includes a DC motor.

9. The apparatus claim 3 further comprising a sensor for determining whether the support mechanism is in the first position or in the second position.

10. The apparatus of claim 9 wherein the sensor is connected to the digital computer, and wherein the sensor includes a sensor light source and a sensor light detector, positioned such that the sensor light detector produces a first signal when the support mechanism is in the first position and a second signal when the support mechanism is in the second position, the first signal being distinguishable from the second signal.

11. The apparatus of claim 9 wherein the sensor is connected to the digital computer, and wherein the sensor is selected from the group consisting of:
a circuit that is closed when the support mechanism is in the first position and open when the support mechanism is in the second position; and
a circuit that is open when the support mechanism is in the first position and closed when the support mechanism is in the second position.

12. The apparatus of claim 9 wherein the sensor is a switch connected to the digital computer.

13. The apparatus claim 3 further comprising a visual display controllable by the digital computer.

14. The apparatus claim 3 wherein the structure is made of a material substantially translucent to the light emitted by the light source.

15. The apparatus claim 3 wherein the structure is made of a material substantially opaque to the light emitted by the light source, wherein the structure includes apertures in opposed walls of said structure with said apertures being in registration with each other to define a path therethrough for transmitting light through the structure.

16. The apparatus claim 3 wherein the structure is substantially a cell structure.

17. The apparatus of claim 16 wherein the structure includes at least one inlet and at least one outlet capable of allowing circulation of a fluid via at least one inlet and at least one outlet.

18. The apparatus of claim 16 wherein the structure is removable from the apparatus.

19. The apparatus claim 3,
wherein the actuator is a rotational actuator;
wherein in the first position the support mechanism and the target are at a first angle with respect to each other, and in the second position the support mechanism and the target are at a second angle with respect to each other.

20. The apparatus of claim 19, wherein the rotational actuator rotates along an axis of rotation that does not intersect the target substance.

21. The apparatus claim 3,
wherein the target substance is a fluid;
wherein the apparatus further comprises a structure enclosing the support mechanism, the light source, and the light detector; the structure including a first and second translucent region;
wherein the structure includes a first and second region, the light source contained in the first region, and the light detector contained in the second region;
wherein the first translucent region is a tube that substantially intersects the straight light path when in the first position, and the second translucent region is a pair of opposing windows that substantially intersects the straight light path when in the second position.

22. The apparatus of claim 21, wherein the first and second region are substantially tubular in shape, and wherein the actuator is a linear actuator.

23. The apparatus claim 3 further comprising a second light detector for measuring an intensity of the light source, wherein the digital computer is capable of receiving signals from the second light detector.

24. The apparatus claim 3 further including a focusing lens that intersects the straight light path and is capable of focusing light on the light detector.

25. The apparatus claim 3 wherein the light source is selected from the group consisting of: mercury lamp, deuterium lamp, xenon lamp, tungsten lamp, halogen lamp, and LED.

26. The apparatus claim 3 wherein the light source is capable of emitting light of a predetermined wavelength spectrum.

27. The apparatus claim 3 wherein the light source includes a filter that is substantially translucent to the predetermined wavelength spectrum.

28. The apparatus claim 3 wherein the light source includes a plurality of light sources wherein each light source emits light such that plurality of light sources collectively emit light of the predetermined wavelength spectrum.

29. The apparatus claim 22 wherein the predetermined wavelength spectrum is a substantially continuous band.

30. The apparatus claim 22 wherein the light detector is capable of sending a signal to the digital computer indicating one of: an intensity of a preselected wavelength, an intensity of a preselected set of wavelengths, and an intensity spectrum of a preselected set of wavelengths.

31. The apparatus claim 3 wherein the light source is capable of emitting light of different sets of predefined wavelength spectrums determined by signals received from the digital computer.

32. The apparatus of any one of claim 3 wherein the light source and the light sensor are separated by a distance between about 1 mm and about 600 mm.

33. A method for measuring a transmittance of light through a target substance, the method comprising:
(a) providing an apparatus comprising:
a light source for emitting light;
a light detector for detecting an intensity of light;
a support mechanism on which the light source and the light detector are mounted in a spaced apart relationship thereby defining a straight light path from the light source to the light detector; and
an actuator for engendering relative motion between the support mechanism and the target substance to at least a first position and a second position, where in the first position the target substance substantially intersects the light path and in the second position the target substance does not substantially intersect the light path;
(b) performing a first measurement step and a second measurement step in either order,
the first measurement step including signaling the actuator to move to the first position and subsequently storing in memory a first value corresponding to a first signal received from the light detector; and
the second measurement step including signaling the actuator to move to the second position and subsequently storing in memory a second value corresponding to a second signal received from the light detector.

34. The method of claim 33,
wherein the support mechanism is movable to at least a first and a second position with respect to the target;
wherein the first measurement step includes signaling the actuator to move the support mechanism to the first position; and
wherein the second measurement step includes signaling the actuator to move the support mechanism to the second position.

35. The method of claim 34, further comprising the step of: computing a ratio of the first value and the second value.

36. The method of claim 35, wherein prior to step (b), the method further comprises, prior to the first measurement step:
providing power to the light source, and
waiting a predetermined length of time.

37. The method of claim 34 further comprising the step of: computing an absorbance of the target by computing a negative logarithm of the ratio of the first value and the second value.

38. The method of claim 35 further comprising the step of: comparing the ratio of the first value and the second value to previously calculated ratios.

39. The method of claim 38 further comprising the step of: computing, using a correction algorithm, an adjusted value from the ratio of the first value and the second value.

40. The method of claim 39 wherein the correction algorithm is a lookup-table of values.

41. The method of claim 39 wherein the correction algorithm is a function of the ratio of the first value and the second value.

42. The method of claim 33 further comprising the step of:
receiving signals from the light detector,
displaying a notification when the received signals from the light detector are substantially within a pre-defined range.

43. The method of claim 33 further including the step of: predicting an output light intensity of the light source as a function of previous signals received from the light detector.

44. The method of claim 33 further including the step of:
providing a second light detector for measuring a light intensity of the light source;
modifying the computed ratio of the first value and the second value as a function of signals received from the second light detector.
